(19) United States
(12) Patent Application Publication
(10) Pub. No.: US 2024/0399679 A1
(43) Pub. Date: Dec. 5, 2024

(54) METHODS OF PREPARING PLANT-BASED PREPREGS FOR COMPOSITE LAMINATES

(71) Applicant: Washington State University, Pullman, WA (US)

(72) Inventors: Vikram Yadama, Pullman, WA (US); Lloyd V. Smith, Pullman, WA (US); Mostafa Mohammadabadi, Starkville, MS (US); Avishek Chanda, Pullman, WA (US); Muhammad Khusairy Bin Bakri, Pullman, WA (US)

(21) Appl. No.: 18/676,570

(22) Filed: May 29, 2024

Related U.S. Application Data
(60) Provisional application No. 63/505,032, filed on May 30, 2023.

(51) Int. Cl. B29C 70/44; B29K 105/08; B29K 311/10; B32B 1/00; B32B 37/06; B32B 37/10

(52) U.S. Cl. CPC B29C 70/443; B32B 1/00; B32B 37/06; B32B 37/10; B29K 2105/0872; B29K 2311/10; B29K 2995/0097; B32B 2260/021; B32B 2260/046; B32B 2262/062; B32B 2307/7376; B32B 2309/022; B32B 2309/04

(57) ABSTRACT

A method of preparing a plant-based prepreg is provided. The method includes adhering a plurality of plant fibers or strands to form a mat or sheet, enclosing the mat or sheet within a vacuum bag having an inlet and outlet, applying a vacuum pressure to the vacuum bag, passing a resin through the inlet to infuse the resin into the mat or sheet; and removing the vacuum bag to provide the plant-based prepreg. A laminated composite material may be prepared by layering a plurality of plant-based prepregs and applying heat and compression to the layered plant-based prepregs to provide the laminated composite material.

### CROSS REFERENCE TO RELATED APPLICATIONS

This application claims the benefit of U.S. Provisional Patent Application 63/505,032 filed on May 30, 2023, and incorporates said provisional application by reference into this document as if fully set out at this point.

### STATEMENT REGARDING FEDERALLY SPONSORED RESEARCH OR DEVELOPMENT

This invention was made with government support under grant no. 2016-67021-24413 awarded by the United States Department of Agriculture through the National Institute of Food & Agriculture. The government has certain rights in the invention.

### FIELD OF THE INVENTION

The embodiments herein relate to methods of preparing prepregs from plant fibers or strands. The prepregs may be used to produce laminated composite materials with applications in various industries such as the automotive and aerospace industries.

### BACKGROUND

Synthetic fibers are strong and stiff with lower density than metals and are in use in almost every type of advanced engineering structure from aerospace, marine, and automotive to sport and biomedical. However, in addition to being expensive, they do not degrade at the end of their life. Although a small fraction of these synthetic composites are crushed into powder and used as filler or incinerated to obtain energy in the form of heat, most of them are not recycled and end up in land-fills. Environmental issues have motivated governmental actions in the form of environmental regulations to protect the environment for future generations. To increase the biodegradation and recyclability of products, and reduce the use of petroleum sources, natural fibers have received considerable attention from both academia and industry. Since natural fibers are renewable, degradable, carbon negative, nonabrasive, have less emission of toxic fumes, and are abundant, there has been an increase in natural fiber composites (NFCs) research for a variety of applications including aerospace and automotive. Due to these advantages, NFCs are a realistic alternative to synthetic composites that meet the requirements of the automotive industry for both exterior and interior applications. However, one challenge with NFC utilization in the automotive sector is the capital requirements and risk averse philosophy associated with high production processes.

Synthetic fiber (i.e. carbon or glass fiber) prepregs are growing in popularity among all segments of the composites industry at 10% per year since 2002. The demand for thermoplastic composites is strong as they can be recycled, and their market size is estimated to grow from USD 22.2 billion in 2020 to USD 31.8 billion by 2025. Considering these aspects, however, the composite industry lacks a natural fiber-based prepreg, analogous to a synthetic fiber prepreg. Thus, natural fiber-based prepregs and methods for preparing natural composite materials are needed.

### SUMMARY

The embodiments herein generally entail a method to produce a natural fiber prepreg with a thermoplastic resin for use as feedstock for fabricating laminated composite materials, flat or profiled, by compression molding for a variety of applications including automotive interior and exterior panels.

An aspect of the disclosure provides a method of preparing a plant-based prepreg, comprising adhering a plurality of plant fibers or strands to form a preform, enclosing the preform within a vacuum bag having an inlet and outlet, applying a vacuum pressure to the vacuum bag, passing a resin through the inlet to infuse the resin into the preform, and removing the vacuum bag to provide the plant-based prepreg. In some embodiments, the resin is a thermoplastic resin. In some embodiments, the resin has a viscosity of 50-150 cps at 25° C. In some embodiments, the plant fibers or strands are obtained from wood. In some embodiments, the plant strands have an average thickness of 0.2 to 0.7 mm. In some embodiments, the plant-based prepreg has an average thickness of up to 12 mm. In some embodiments, the method further comprises placing a resin flow media layer on an upper surface of the preform before the enclosing step and removing the resin flow media layer after removing the vacuum bag. In some embodiments, the plurality of plant fibers are adhered and compressed to form the preform.

Another aspect of the disclosure provides a plant-based prepreg prepared by a method as described herein.

Another aspect of the disclosure provides a method of preparing a laminated composite material, comprising layering a plurality of plant-based prepregs prepared by a method as described herein and applying heat and compression to the layered plant-based prepregs to provide a laminated composite material. In some embodiments, the applying step is performed by heating the layered plant-based prepregs to a temperature of 170-190° C. at a pressure of 810-850 kPa. In some embodiments, the applying step is performed for 1-30 minutes. In some embodiments, the method further comprises cooling the laminated composite material to a temperature below 80° C. before removing the compression. In some embodiments, the method further comprises shaping the laminated composite material into a three dimensional configuration. In some embodiments, the three dimensional configuration comprises a dome shape. In some embodiments, the dome shape has a forming ratio of 2 or less.

Another aspect of the disclosure provides a laminated composite material prepared by a method as described herein. In some embodiments, the laminated composite material is shaped into a three dimensional configuration.

Other features and advantages of the present invention will be set forth in the description of invention that follows, and in part will be apparent from the description or may be learned by practice of the invention. The invention will be realized and attained by the compositions and methods particularly pointed out in the written description and claims hereof.

### BRIEF DESCRIPTION OF THE FIGURES

FIG. 1. A brief pictorial summary of wood strand prepreg and composite laminate process.

FIG. 2A-D. Prepreg development (a) wood strand mat indicating longitudinal and transverse directions (b) preform under vacuum bagging (c, d) thin and flexible prepreg.

FIG. 3A-C. Tensile coupons (a) plain strand, (b) resin-saturated strand, and (c) large coupons having fiber discontinuity cut from wood prepreg in longitudinal direction.

FIG. 4A-E. Scanning electron microscope evaluation (a) both sides of plain, partially, and fully resinated, (b) plain strands, (c) partially resinated, (d, e) fully resinated strands.

FIG. 5A-C. Different types of shear failure (a) pure adhesion failure, (b) partial fiber failure, and (c) pure fiber failure.

FIG. 6A-B. Results of mechanical testing (a) modulus of elasticity and (b) strength compared with other materials.

FIG. 7A-B. Comparison between (a) water absorption and (b) thickness swelling of wood prepreg laminate with other bio-based composites.

FIG. 8. A graphical illustration of the prepreg fabrication steps and the final product.

FIG. 9A-C. Micrographs of the raw sisal fibers and fiber bundles used in the study showing (a) fiber bundle, (b) single fiber, and (c) lumen structure.

FIG. 10. Tensile properties of the single sisal fibers used in the current study.

FIG. 11A-B. Diagram of VARTM assemblies (a) without and (b) with gap between the preform boundary and the outlet.

FIG. 12A-B. Illustration of (a) TGA and DTG analyses and (b) DMA study conducted on the sisal fiber reinforced Elium® composite prepregs.

FIG. 13A-C. Micrographs illustrating (a-c) the lumen saturation extent of the sisal fibers.

FIG. 14. Diagram of the thermo-forming process.

FIG. 15A-B. Micrographs of the (a-b) tested tensile coupons at the breakage surface.

FIG. 16A-E. Different orientations for the prepreg layers with a laminate (a) unidirectional, (b) 0°/90°/0°/90°/0°, (c) 0°/45°/0°/45°/0°, (d) 0°/45°/90°/45°/0°, and (e)+45°/−45°/0°/+45°/−45°.

FIG. 17A-C. Three types of forming were tested: (a) single-axis forming (Vee-bending), (b) bi-axial forming (dome forming), and (c) multi-axial forming (3D wafer mold).

FIG. 18A-D. (a) Top and (b) side view of forming rate of 1 in/min and (c) top and (d) side view of forming rate of 0.5 in/min.

FIG. 19A-B. Dome shape after forming rate of (a) 0.5 in/min and (b) 0.1 in/min.

FIG. 20A-D. Dome shape (a) top and (b) bottom view after forming ratio of 3 and (c) top and (d) bottom view after forming ratio of 2.

### DETAILED DESCRIPTION

In the description of the invention herein, it is understood that a word appearing in the singular encompasses its plural counterpart, and a word appearing in the plural encompasses its singular counterpart, unless implicitly or explicitly understood or stated otherwise. Furthermore, it is understood that for any given component or embodiment described herein, any of the possible candidates or alternatives listed for that component may generally be used individually or in combination with one another, unless implicitly or explicitly understood or stated otherwise. Moreover, it is to be appreciated that the figures, as shown herein, are not necessarily drawn to scale, wherein some of the elements may be drawn merely for clarity of the invention. Also, reference numerals may be repeated among the various figures to show corresponding or analogous elements. Additionally, it will be understood that any list of such candidates or alternatives is merely illustrative, not limiting, unless implicitly or explicitly understood or stated otherwise. In addition, unless otherwise indicated, numbers expressing quantities of ingredients, constituents, reaction conditions and so forth used in the specification and claims are to be understood as being modified by the term “about.”

Accordingly, unless indicated to the contrary, the numerical parameters set forth in the specification and attached claims are approximations that may vary depending upon the desired properties sought to be obtained by the subject matter presented herein. At the very least, and not as an attempt to limit the application of the doctrine of equivalents to the scope of the claims, each numerical parameter should at least be construed in light of the number of reported significant digits and by applying ordinary rounding techniques. Notwithstanding that the numerical ranges and parameters setting forth the broad scope of the subject matter presented herein are approximations, the numerical values set forth in the specific examples are reported as precisely as possible. Any numerical values, however, inherently contain certain errors necessarily resulting from the standard deviation found in their respective testing measurements.

Embodiments of the disclosure provide methods for producing a plant-based prepreg, comprising adhering a plurality of plant fibers or strands to form a preform, enclosing the preform within a vacuum bag having an inlet and outlet, applying a vacuum pressure to the vacuum bag, passing a resin through the inlet to infuse the resin into the preform, and removing the vacuum bag to provide the plant-based prepreg.

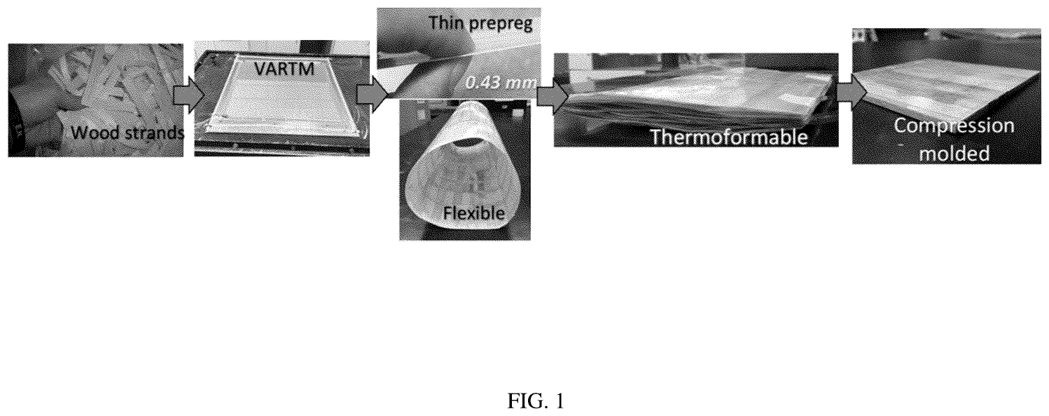

Any plant-based natural fiber or strand may be utilized in a method as described herein. For example, fibers may be acquired from agricultural by-products, different parts of plants and fruits, and parts of crops. Fibers obtained from various parts of a plant can be broadly classified as vegetable fibers including bast or stem fibers (jute, masa, banana, hemp), leaf fibers (sisal, pineapple, screw pine, palm) and fruit fibers (cotton, coir, oil palm). The most significant advantage of vegetable fibers is the presence of cellulose, whose elementary unit is anhydro-d-glucose, containing three alcohol hydroxyl (OH) groups. These hydroxyl groups result in intramolecular and intermolecular bonds, forming hydrogen bonds both inside the macromolecule and with other cellulose units, while also reacting with the air's hydroxyl groups. These numerous reactions make the vegetable fibers hydrophilic, with a moisture content of 1% to 13%. Another important component in these fibers is lignin, which acts as the cementing agent and influences its morphology, properties and structure. Degree of polymerization is an important characteristic in selecting a plant fiber for its intended application, with those having the highest being traditionally used for high-strength applications such as gummy bags, ropes cords and others. Thus, vegetable fibers can also be classified as naturally occurring composites, like wood, with cellulose fibrils encapsulated in a lignin matrix. These fibrils are generally aligned along the length of the fibers in all types, imparting the maximum possible flexural and tensile strengths while also providing rigidity in that particular fiber direction. These fibers also have high specific stiffness and strength, resulting in their possible utilization as reinforcements in polymeric matrices. In some embodiments, the fiber is classified as a lignocellulosic fiber. In some embodiments, the natural fibers may be provided as strands, e.g. wood strands as shown in FIG. 1. The strands may have an average thickness of 0.1-1 mm, e.g. 0.2 to 0.7 mm. A composite of different types of natural fibers may also be utilized.

The natural fibers or strands are first adhered together to form a preform, i.e. a mat or sheet of the adhered fibers/strands. Adhering may be performed using a glue, binder, or other adhesive. Alternatively, adhering may be performed by simply gathering the fibers or strands together without an adhesive (and optionally pre-compressed) or by a mechanical means such as stitching. The fibers may be in the form of a nonwoven (fibers that are entangled, needled, or meshed together, e.g. a fiberboard material) or may be in a woven form (e.g. one or more pieces of cloth or fabric). In some embodiments, the fibers or strands are adhered in a random orientation. In other embodiments, the fibers or strands are adhered unidirectionally or in a patterned orientation. Natural fiber prepregs that can be thermoformed into flat and three-dimensional profiles without altering processability and manufacturing costs compared to their synthetic counterparts are generally attractive.

In some embodiments, the adhered fibers or strands are compressed before being enclosed in the vacuum bag. Compression is useful for obtaining a final product with a higher density and to decrease voids.

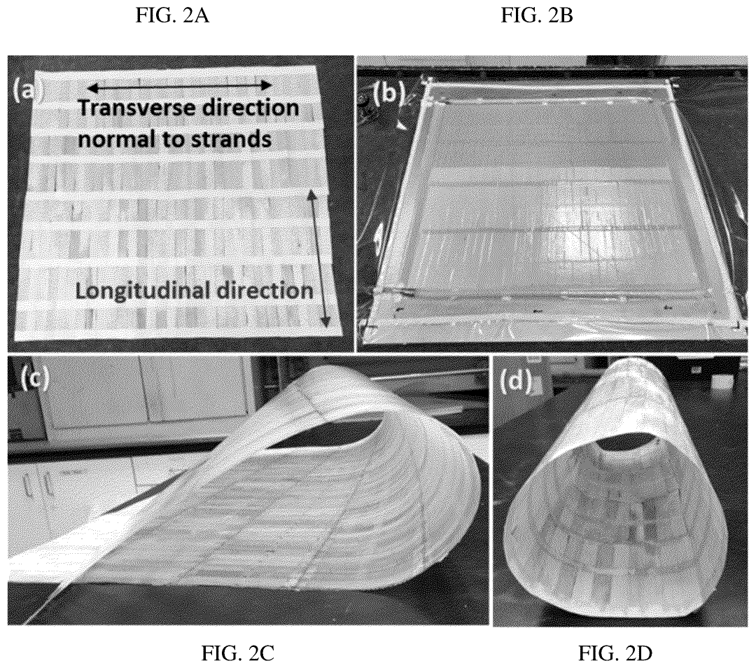

The adhered fibers or strands form a preform which is then enclosed in a vacuum bag for vacuum-assisted resin transfer molding (VARTM), a type of liquid molding (FIGS. 2, 8, and 11). The preform may be placed on a solid support, e.g. fiberglass, and a flexible membrane (vacuum bag) is arranged over the preform. Suitable vacuum bags are known in the art, e.g. a silicone material, polymer film, etc. The VARTM process is carried out under a vacuum and may impart atmospheric pressure of at least 1 bar when the vacuum is completely pulled. The vacuum pressure facilitates resin flow into the preform from an inlet of the bag to an outlet. The vacuum pressure may be applied for a period of 1-30 minutes. In preferred embodiments, the VARTM process is performed at room temperature, e.g. about 20-25° C. After impregnation of the resin, the preform is allowed to cure, e.g. at room temperature. In some embodiments, a fabric layer, (e.g. a peel-ply) is placed on an upper surface of the sheet before the preform is enclosed in the bag. The fabric layer is then removed after the VARTM process and the resin has cured. A resin flow media layer (or distribution media layer) may be added so that the peel-ply is between the preform and the resin flow media layer. The peel-ply is to ensure that the preform does not stick to the resin flow media layer, which allows the resin to flow more easily.

Preferred embodiments utilize a thermoplastic resin. In some embodiments, the resin is a low-viscosity liquid thermoplastic resin, e.g. a resin having a viscosity of 25-500 cps, e.g. 50-150 cps at 25° C. Exemplary resins include, but are not limited to, Elium® resins as sold by Arkema. An initiator, e.g. organic peroxide and/or photoinitiators, may be added to the resin to aid polymerization.

As demonstrated in Example 2, an increase in resin content is directly proportional to an increase in the gap between the preform and the outlet of the vacuum bag, with a possible mathematical relationship of about a 9% increase in resin content with every 25.4 mm (1 inch) increase in the gap. An increase in resin content may be accompanied by reduced fiber volume fraction reduced strength. Thus, embodiments provide for an assembly with a minimal (e.g. less than about 0.5 inch) or no gap between the outer boundary of the preform and the outlet port.

After the VARTM process is complete, a plant-based prepreg is provided. A prepreg is a material made from impregnated fibers and a partially or fully cured polymer matrix. In some embodiments, the prepreg has an average thickness of 0.1-15 mm, e.g. 1-12 mm. Embodiments of the disclosure include plant-based prepregs prepared by a method as described herein.

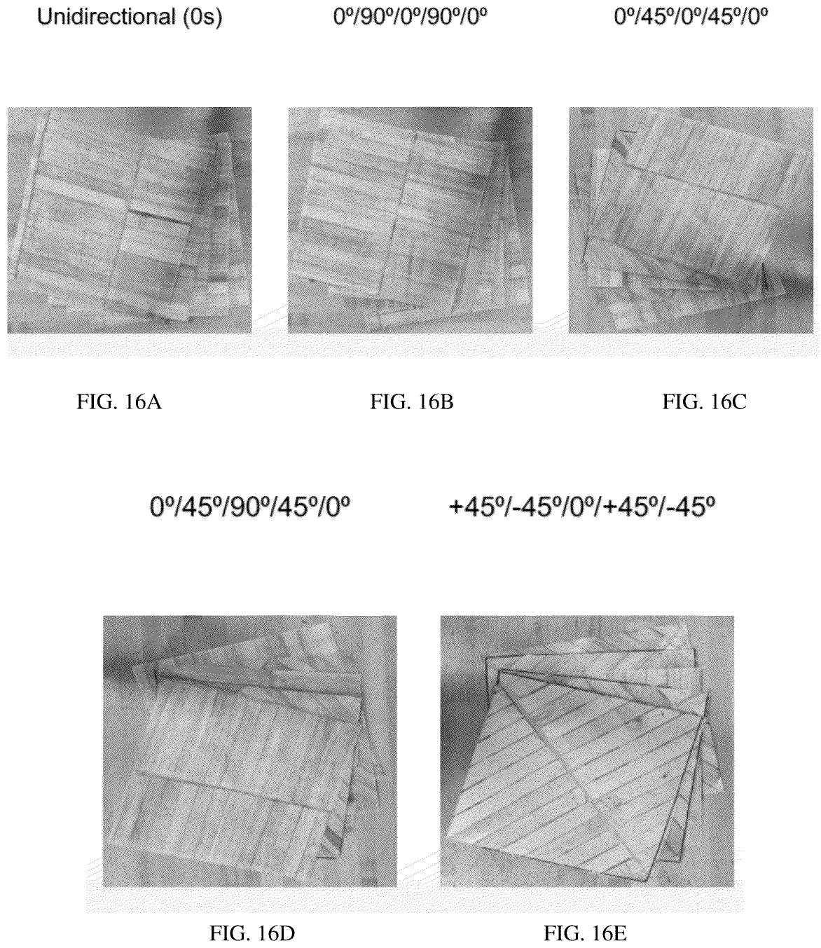

Further embodiments include a method of preparing a laminated composite material, comprising layering a plurality of plant-based prepregs prepared by a method as described herein and applying heat and compression to the layered plant-based prepregs to provide a laminated composite material. Any number of prepregs, e.g. 2-100 prepregs or more, may be layered to form the composite. The prepreg layers may be unidirectional relative to each other or may have a random orientation. In some embodiments, each layer is rotated in a predetermined pattern, e.g. between 0-90° as shown in FIG. 16. Embodiments of the disclosure include laminated composite materials prepared by a method as described herein.

In some embodiments, the applying step is performed by heating the layered plant-based prepregs to a temperature of 100-300° C., e.g. 170-190° C. at a pressure of 700-1000 kPa, e.g. 810-850 kPa. In some embodiments, the applying step is performed for 2-100 minutes, e.g. 5-30 minutes. In some embodiments, the method further comprises cooling the laminated composite material to a temperature below about 100° C., e.g. below 80° C., before removing the compression.

The laminated composites are useful in various applications and may be used flat or further shaped into a three dimensional configuration, e.g. for use as internal or external automotive parts (e.g. seats, dash boards, glove boxes, headliners, or other panels). Such configurations may include various bent and dome shapes. In preferred embodiments, if a dome shape is formed, it has a forming ratio of 2 or less in order to reduce the likelihood of defects. The forming ratio is r/t where r is the radius of forming and t is the thickness of the laminate formed. The shaping of the laminated composite may occur during the applying step under heat and pressure. Alternatively, the shaping may occur after the applying step.

The prepregs and laminated composites described herein have a wide variety of applications, including in the aerospace, marine, automotive, aviation, construction, sport, architectural, decorative, and biomedical industries. The prepregs or composites may be used for any application in which synthetic fibers, e.g. glass or carbon fibers were previously used.

Another advantage of the disclosed prepregs and composites is that they are fully recyclable. As described in Example 3, the prepregs or composites can be milled into smaller particles. The milled particles may optionally be mixed with a polymer and then molded into new materials with excellent mechanical properties.

While the present invention has been illustrated by the description of embodiments thereof and specific examples, and while the embodiments have been described in considerable detail, it is not intended to restrict or in any way limit the scope of the appended claims to such detail. Additional advantages and modifications will readily appear to those skilled in the art. Thus, the invention in its broader aspects is therefore not limited to the specific details, representative apparatus and methods and illustrative examples shown and described. Accordingly, departures may be made from such details without departing from the scope or spirit of applicant's general inventive concept.

It is to be understood that this invention is not limited to particular embodiments described herein above and below, and as such may, of course, vary. It is also to be understood that the terminology used herein is for the purpose of describing particular embodiments only, and is not intended to be limiting.

Where a range of values is provided, it is understood that each intervening value between the upper and lower limit of that range (to a tenth of the unit of the lower limit) is included in the range and encompassed within the invention, unless the context or description clearly dictates otherwise. In addition, smaller ranges between any two values in the range are encompassed, unless the context or description clearly indicates otherwise.

Unless defined otherwise, all technical and scientific terms used herein have the same meaning as commonly understood by one of ordinary skill in the art to which this invention belongs. Representative illustrative methods and materials are herein described; methods and materials similar or equivalent to those described herein can also be used in the practice or testing of the present invention.

All publications and patents cited in this specification are herein incorporated by reference as if each individual publication or patent were specifically and individually indicated to be incorporated by reference, and are incorporated herein by reference to disclose and describe the methods and/or materials in connection with which the publications are cited. at which the cell reaction takes place

The citation of any publication is for its disclosure prior to the filing date and should not be construed as an admission that the present invention is not entitled to antedate such publication by virtue of prior invention. Further, the dates of publication provided may be different from the actual dates of public availability and may need to be independently confirmed.

It is noted that, as used herein and in the appended claims, the singular forms “a”, “an”, and “the” include plural referents unless the context clearly dictates otherwise. It is further noted that the claims may be drafted to exclude any optional element. As such, this statement is intended to serve as support for the recitation in the claims of such exclusive terminology as “solely,” “only” and the like in connection with the recitation of claim elements, or use of a “negative” limitations, such as “wherein [a particular feature or element] is absent”, or “except for [a particular feature or element]”, or “wherein [a particular feature or element] is not present (included, etc.) . . . ”.

As will be apparent to those of skill in the art upon reading this disclosure, each of the individual embodiments described and illustrated herein has discrete components and features which may be readily separated from or combined with the features of any of the other several embodiments without departing from the scope or spirit of the present invention. Any recited method can be carried out in the order of events recited or in any other order which is logically possible.

### EXAMPLES

### Example 1

A wood-based prepreg was formed using vacuum-assisted resin transfer molding (VARTM) and a low-viscosity thermoplastic resin. Wood strands were assembled to make a porous mat for resin injection. The resin filled most of the cavities inside the wood cells resulting in a void volume fraction of 7%. The Young's modulus and strength of the saturated wood strands were 38% and 124% higher, respectively, than those of wood strands prior to resin infusion. Flat laminates were produced by thermoforming prepreg plies at 180° C. and 830 kPa, for 25 min. The Young's modulus and strength of flat 12-ply laminates were 73% and 20% higher, respectively, than a wood-strand panel produced using compression resin transfer molding (CRTM) and epoxy resin. Wood prepreg is an alternative to traditional wood composite forming processes, and can simplify the manufacture of complex shapes, while improving the properties of the natural material. Production process of wood strand prepreg and a composite laminate using prepregs is depicted in FIG. 1.

### Materials

Thin wood strands measuring 146×19×0.36 mm were produced from small diameter trees (ponderosa and lodgepole pine logs ranging in diameter from 191 to 311 mm) and dried to approximately 1% MC. Wood strand mats were assembled using strips of tacky paper (Super 77 Multipurpose Adhesive by 3M), as shown in FIG. 2A. The preform was placed under peel ply and vacuum bagged using VARTM as shown in FIG. 2B. Spiral tubes under the bagging film on both ends of the preform were attached to the resin inlet and outlet for an even flow of resin. A low-viscosity resin (Elium® 150, Arkema, Prussia, PA) was mixed with 3% initiator (Luperox® AFR40 benzoyl peroxide) prior to injection. Elium® is a thermoformable, infusible, and recyclable acrylic thermoplastic resin and has high mechanical properties and compatibility with conventional thermoset processes. Fiber-reinforced Elium® resin can be thermoformed with heat and pressure as the resin undergoes a radical polymerization to produce a thermoplastic matrix after injection and the curing process. Resin-injected prepregs were then allowed to cure at room temperature. At room temperature, the resin system has a viscosity of 100 cps, open time of 20 min, and cure time of 40 min. A finished wood prepreg with an average thickness of 0.43 mm is shown in FIG. 2C-D.

### EXPERIMENTS

### Strands and Prepregs

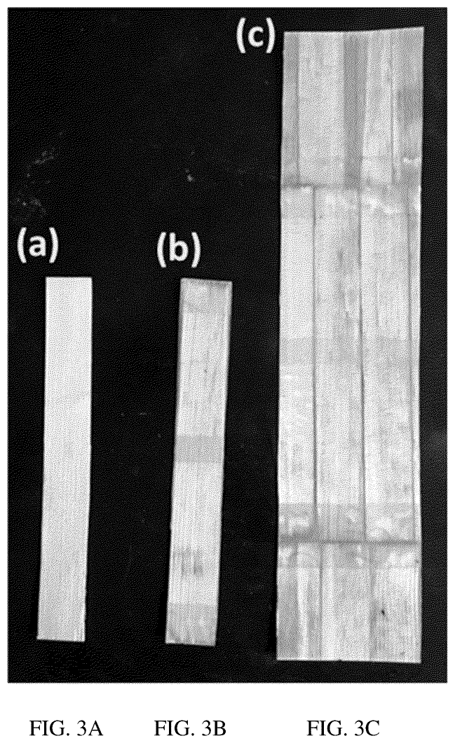

To determine the level of resin saturation, unprocessed plain wood strands were compared with the prepreg under a scanning electron microscope (SEM). The effect of VARTM was determined by comparing the mechanical properties of unprocessed strands to those that are resin saturated (shown in FIG. 3A-B) using the mechanical test coupons described in Table 1. To examine the effect of fiber discontinuity, the mechanical properties of the prepreg were evaluated by testing large samples cut in the longitudinal direction as shown in FIG. 3C.

TABLE 1
Dimensions of specimens used for mechanical testing (all are in mm).

| | | Details such as size, | | | Length | | | |
|---|---|---|---|---|---|---|---|---|
| Material | Test | shape, and direction | | # | Total | Active^{a} | Width | Thickness |
| Plain | Tensile | Rectangle-longitudinal | | 15 | 146 | 96 | 19 | 0.40 |
| strand | | | | | | | | |
| Prepreg | Tensile | Strand | Rectangle- | 33 | 146 | 96 | 19 | 0.43 |
| | | size | longitudinal | | | | | |
| | | Large | Rectangle- | 35 | 255 | 166 | 51 | 0.45 |
| | | Coupon | longitudinal | | | | | |

| | | | | | | | |
|---|---|---|---|---|---|---|---|
| Laminate | Tensile^{b} | Dog bone-longitudinal | 6 | 255 | 166 | 39^{c} | 5 |
| | Bending | Rectangle-longitudinal | 5 | 185 | 140 | 51 | 5 |
| | WA-TS | Square | 5 | 153 | — | 153 | 5 |

^{a}Active length is the length between two grips for tensile and two supports for bending specimens.
^{b}Fillet radius was 76 mm and gauge length was 51 mm.
^{c}This dimension is width of the reduced section.

Since fiber content is a key factor for prepregs and composite materials, the following procedure was used to determine fiber, resin, and void volume fractions of the wood prepreg. The weight difference of the wood strand preform (FIG. 2A) before resin injection (M_{F}) and the prepreg after cure (M_{C}) (FIG. 2C-D) were used to obtain the resin weight (M_{R}). Wood strands are composed of wood fibers that include the cell wall material (assumed to include the interfibrillar and cell wall void as well) and the fiber lumen (void in the fiber core). The wood fiber volume, V_{F}, was found from the wood cell wall density, ρ_{w}, (1524 kg/m³) as

$${V}_{F} = {M}_{F} / {ρ}_{W} \qquad ( 1 )$$

Knowing the volume of the composite (V_{C}) by measuring the dimensions of the wood prepreg, the void volume, V_{V}, was found from

$${V}_{V} = {V}_{C} - {V}_{F} - {V}_{R} = {V}_{C} - \frac{{M}_{F}}{{ρ}_{W}} - \frac{{M}_{R}}{{ρ}_{R}} \qquad ( 2 )$$

where V, M, and ρ are volume, mass, and density, and subscripts C, F, R, W refer to composite, fiber, resin, and wood cell wall, respectively. Knowing the volume of fiber, resin, and void, the volume fractions were computed with respect to the volume of the composite.

### Composite Laminates

To laminate layers of prepreg into a composite laminate, the prepreg thermoforming temperature must be higher than its glass transition temperature (Tg) and lower than its thermal degradation temperature. Dynamic mechanical analysis (DMA) and thermogravimetric analysis (TGA) tests were conducted to find these temperature limits. For the DMA test, both single prepreg plies and 6-ply laminates were evaluated, while 12 g prepreg samples were used for the TGA analysis.

To achieve good bonding between the prepreg plies, a suitable temperature and pressure for thermoforming were determined. Twelve plies of prepreg were hot-pressed at different temperatures and pressures to make flat laminates and tested using the shear block test to evaluate the bonding between prepreg plies. To have specimens with the desired thickness for shear block tests, samples cut from laminates were sandwiched between two layers of a wood-strand panel. The midplane of the 12-layer-prepreg laminate was the plane subjected to shear by compression loading.

Composite laminates consisting of 12 plies of wood strand prepreg were produced under the predetermined conditions for mechanical testing. Specimens cut from these laminates were submitted to tensile, bending, and water absorption (WA) and thickness swelling (TS) tests. The dimensions of these specimens are given in Table 1.

### Results and Discussion

### Strand Impregnation

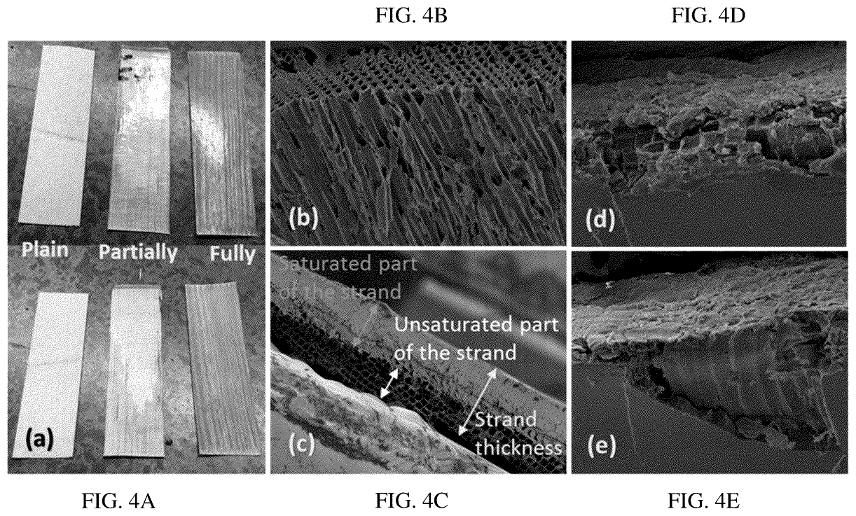

The average thickness of the prepreg was 0.43 mm with COV of 5%. Three samples, fully resinated, partially resinated, and plain strands shown in FIG. 4A were evaluated under SEM to see how resin permeates throughout wood strands. Partially resinated samples were cut from regions where one side of the strand was wetted by resin whereas the other side was dry. This method resulted in good quality prepreg and partially resinated only occurred in two prepreg samples in regions close to the resin outlet. Empty lumens can be seen in FIG. 4B for plain strands. It can be seen how fiber lumens of fully saturated strands shown in FIG. 4D-E have been filled with resin. For partially resinated strands, where the resin could reach just one side of the strands, only half of the fiber lumens have been filled as shown in FIG. 4C. Unlike thermoplastic polymers such as polypropylene and polyethylene which only encapsulate the wood particles when used in wood thermoplastic composites, SEM images demonstrate that the low-viscosity thermoplastic resin used in this study can not only encapsulate the wood fibers, but can also penetrate the fiber lumens within the strands of the prepreg. In addition, the effect of penetration of high-density polyethylene (HDPE) in different wood species (lodgepole pine, grand fir, and Douglas fir) was evaluated using vacuum bagging, and the results showed that the penetration parallel to resin flow varies between 0.04 and 0.1 mm for both carlywood and latewood. However, the low-viscosity thermoplastic resin in this study was able to penetrate the whole thickness of the wood strands (0.4 mm), which was normal to resin flow.

### Experimental Mechanical Properties of Prepreg

Saturated strands, cut from prepreg, along with plain strands, were submitted to tensile tests to compare the effect of VARTM on strand mechanical properties, as shown in Table 2. The average Young's modulus and strength of saturated strands increased by 38% and 124% compared with those of plain strands, respectively.

TABLE 2
Mechanical properties of Elium ®, plain strands,
saturated strands, and coupons cut from
wood prepreg (COV is mentioned in parenthesis).

| | | | Saturated strands | | Longi- |
|---|---|---|---|---|---|
| | | | | Rule | tudinal |
| | | Plain | Experi- | of | prepreg |
| | Elium ® | strands | ment | mixtures | specimens |
| Young | 3.3 | 9.82 | 13.58 | 12.92 | 10.03 (20%) |
| modulus | | (28%) | | | |
| (GPa) | | | (13%) | | |
| Strength | 76 | 46 | 103 (20%) | 102 | 32 (47%) |
| (MPa) | | (45%) | | | |

Since the wood strands in the prepreg are not continuous, larger specimens (shown in FIG. 3B) were cut from the prepreg in the longitudinal direction and tensile tested. Because of the discontinuity between the strands, the mechanical properties of these specimens given in Table 2 are lower than those of saturated strands having no discontinuity.

### Analytical Mechanical Properties of Prepreg

Fiber, resin, and void volume fractions of the prepreg were found to be 25%, 68%, and 7%, respectively. Knowing these properties, the rule of mixtures can be used to predict ideal continuous fiber material properties of saturated strands by

E_{SS}=v_{F}E_{F}+v_{R}E_{R} and Uₛₛ=v_{F}U_{F}+v_{R}U_{R} (3)

where E and U are Young's modulus and strength, v is the volume fraction, subscript SS refers to saturated strand, subscript F refers to fiber, and subscript R refers to resin. The stiffness and strength of plain strands depend on the strand fiber volume fraction (v_{PS}) as

E_{PS}=v_{PS}E_{F} and U_{PS}=v_{PS}U_{F} (4)

where PS stands for plain strand and v_{PS} is the average fiber volume fraction in plain strands which using Eq 1 and physical properties of the plain strands (dimensions and mass) was found to be 0.23. The measured and predicted saturated strand modulus and strength are compared in Table 2. Good agreement was found (within 5% for Young's modulus and 1% for strength) due to uniform resin penetration into the fiber lumens.

### Thermoforming Variables

The glass transition and thermal degradation temperatures were found to be 132° C. and 257° C., respectively. Since hemicelluloses, a primary constituent of the wood cell wall, begins to degrade at around 220° C., a temperature of 200° C. was used as the upper thermoforming limit. The effect of the processing temperature (140, 160, and 180° C.), pressure (380, 555, 690, 830 kPa), and thermoforming duration (15 and 25 min) were evaluated using the shear block test.

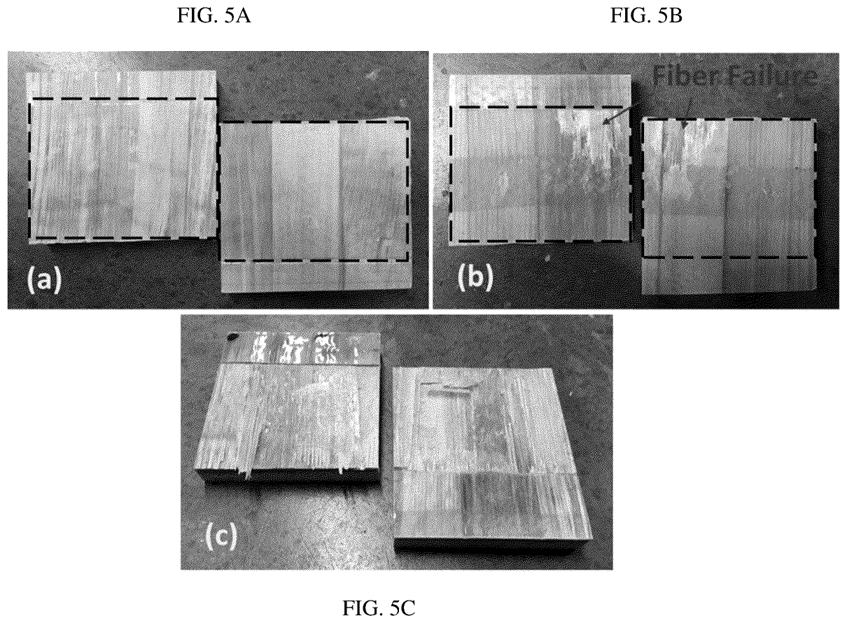

A thermocouple was placed at the mid plane of 12-ply laminates to monitor temperature, which, on average, required 6 min to reach the target temperature. Laminates were left under pressure for an additional 19 min (25 min thermoforming duration). The laminates cooled under pressure to 80° C. at which point the laminate was unloaded and removed from the press. The shear strength of six specimens cut from each laminate is reported in Table 3, which tended to increase with temperature and pressure (except for 555 kPa and 180° C.). The fiber and matrix demonstrated good adhesion with increasing the temperature and pressure as specimens failed due to fiber failure rather than adhesion. Different types of shear failure are shown in FIG. 5 (the bonding area of shear block specimens is indicated by dashed line).

TABLE 3
Maximum shear stress in samples made under different temperature
and pressures and submitted to shear block test.

| Laminates under target temperature for 25 min but under target pressure until cool down | | | | |
|---|---|---|---|---|
| | Target pressure (kPa) | | | |
| | 380 | 555 | 690 | 830 |

Target temp. (° C.)

| | 140 | 160 | 180 | 160 | 180 | 160 | 180 | 160 | 180 |
|---|---|---|---|---|---|---|---|---|---|
| Shear strength | 1793 | 2868 | 4675 | 2992 | 4199 | 3027 | 5716 | 4730 | 7308 |
| (kPa) (COV %) | (52) | (34) | (46) | (74) | (43) | (32) | (13) | (45) | (12) |

Laminate under target temperature and pressure for specified pressing time with no cooling

| Target pressure (kPa) | 830 | |
|---|---|---|
| Target temp. (° C.) | 180 | |
| Press time (min) | 15 | 25 |
| Shear strength (kPa) | 2551 | 3206 |
| (COV %) | (15) | (30) |

Table 3 includes the effect of the cooling process and pressing time on shear strength. Laminates pressed at 180° C. and 830 kPa were removed from the press prior to cool. For a 25 min press time the shear strength decreased by 56% by removing the cooling step. Reducing the pressing time from 25 to 15 min decreased the shear strength by 20%. These results show that bond strength depends strongly on the hot-press duration and the cooling process. In the following, laminates were formed at 180° C. and 830 kPa for 25 min, and cooled to 80° C. under the target pressure of 830 kPa as these specified thermoforming variables resulted in an excellent bonding between prepreg plies as shown in FIG. 5C.

### Laminate Mechanical Testing

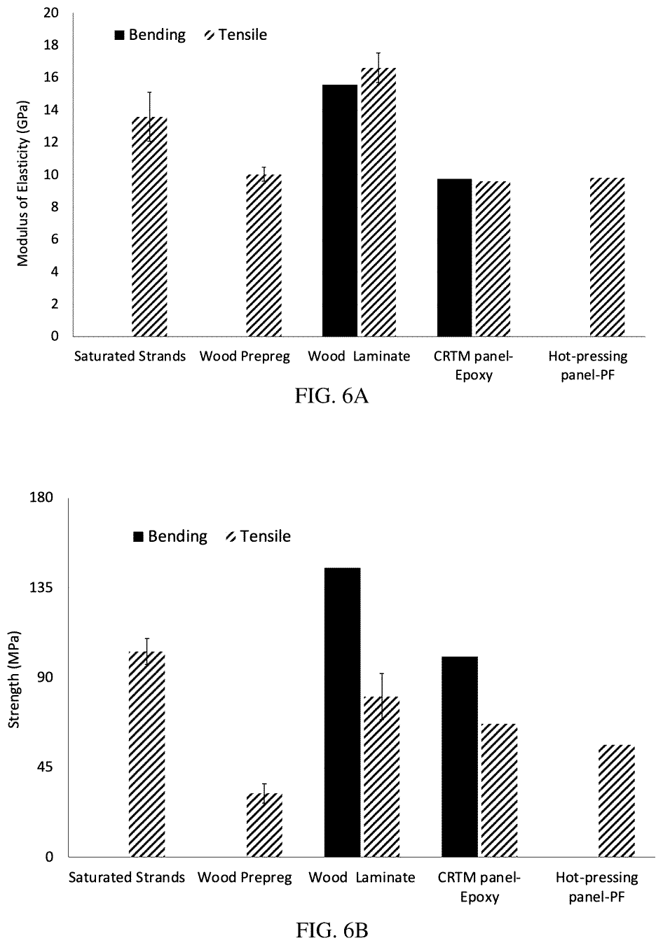

The results of laminate bending and tensile tests are given in FIG. 6. The tensile Young's modulus of the wood prepreg laminate was 66% and 22% larger than the wood prepreg and the saturated strands, respectively, as shown in FIG. 6A. The laminate tensile strength (FIG. 6B) was 150% higher than the prepreg and 22% smaller than the saturated strands. Fiber discontinuity and different densities between specimens cut form the prepreg and laminate likely cause the differences. The average density for wood prepreg was 1026 kg/m³, while it increased by 12% and reached 1151 kg/m³ for flat laminates.

The prepreg laminate is compared in FIG. 6 with that of similar composites fabricated from wood strands but using different manufacturing techniques and resins. RTM with external pressure is known as CRTM and was used to manufacture wood-strand-based composites with Derakane 411-350 epoxy vinyl ester resin. The thickness and fiber volume fraction for this composite were 6.35 mm and 37%, respectively. Densifying the wood strand mat by applying pressure during resin injection and injecting resin with high pressure resulted in fiber compaction and higher fiber volume fraction and less void content compared with the prepreg laminate developed in this study. Another composite was produced by hot-pressing wood strands with a low percentage of phenol formaldehyde resin (8% of the oven-dry weight of the wood strands). The thickness and density of the hot-pressed wood strand composite were 6.35 mm and 640 kg/m³, respectively. The fiber volume fraction of the composite was about 40%. Even though the laminate developed in this study had a lower fiber content compared with the other composites, its modulus of elasticity and strength in tension and bending were noticeably higher. For the bending test, the modulus of elasticity of the laminate was 60% higher than that of the CRTM panel and in tension, it was 73% and 69% larger than CRTM and hot-pressing panels, respectively. The modulus of rupture of the laminate was 44% higher than that of CRTM and its tensile strength was 20% and 42% higher than that of CRTM and hot-pressing panels, respectively. Fiber orientation is one reason for this difference as all wood strands were oriented in the longitudinal direction to make the prepreg as shown in FIG. 2A. For CRTM and hot-pressed panels, however, strands were oriented within +35 degrees with respect to the longitudinal direction. Compared with CRTM specimens with a higher fiber volume fraction of 37%, the laminates yield better mechanical properties which could be due to higher mechanical properties of the thermoplastic resin or improved interaction between the thermoplastic resin and wood strands compared with the low-viscosity thermoset resins used for the CRTM specimens.

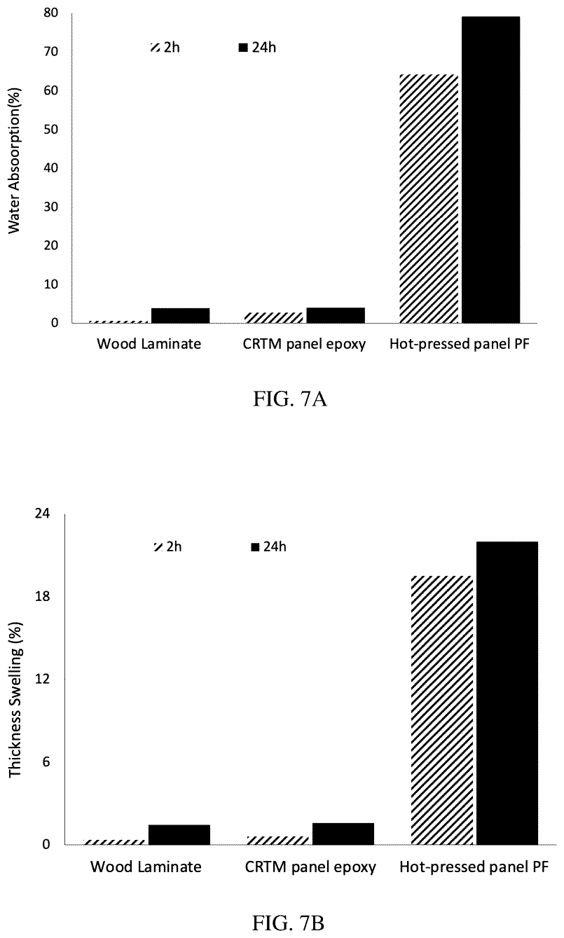

WA and TS of the wood prepreg laminate after 2 and 24 h are shown in FIG. 7A-B and are compared with the wood strand composites produced (using CRTM and hot press). The laminate and CRTM panel showed similar behavior in the presence of water. The wood prepreg laminates showed much better performance compared with hot-pressed panels as the low-viscosity resin during the VARTM process was mostly able to fill all the cavities or fiber lumens within the wood strands. These superior moisture resistant properties are important for automotive applications where shape stability and durability are critical.

### Conclusions

A natural fiber-based thermoplastic prepreg similar to a synthetic prepreg has been developed to manufacture molded and shaped interior panels for a variety of applications, including automotive. Wood strands from small diameter timber were used to develop a wood-based prepreg using a novel thermoplastic resin and VARTM technique. Unlike the traditional thermoplastic resins which penetrate only a few microns into the wood structure, the low-viscosity thermoplastic resin in this study easily penetrated the fiber lumens. This resulted in a low void volume fraction and a high-performance thin wood strand prepreg. The interlaminar shear strength of laminates produced from the wood prepreg increased with the thermoforming duration and cooling under pressure. Due to reprocessability of the wood-based prepregs, they can be used to produce flat or shaped composite laminates, with high strength, stiffness, water resistance, and dimensional stability.

### Example 2

The advancement in bio-degradable and renewable prepregs for various thermoforming applications is critical to reducing the excessive carbon footprint generated by the commonly used synthetic fibers. Based on experience fabricating wood-strand-based prepreg and thermoforming them into laminates, a non-woven sisal fiber mat was similarly utilized to fabricate prepregs using vacuum assisted resin transfer molding. A low-viscosity liquid thermoplastic resin, Elium®, was utilized for the infusion process; it is a reprocessable thermoplastic enabling recycling of composites as an end-of-life option, thus contributing to a circular economy. The acquired non-woven mats were partially consolidated to make a porous media for resin infusion. The SEM analysis showed excellent resin encapsulation and some penetration in the fibers, providing the desirable mechanical interlock and good fiber-matrix interaction. The Young's modulus and tensile strength of prepregs were calculated to be about 3.42 GPa and 18.7 MPa, respectively. Flat laminates with five prepregs were produced at 180° C. and 850 kPa pressure, which were maintained for 25 minutes. The flat laminates experienced about 39% and 43% increase in the Young's modulus and tensile strength, making them comparable to compression molded wood-based epoxy panels and other natural fiber reinforced thermoplastic composites. The prepregs are an alternative to traditionally used synthetic fiber-based prepregs for manufacturing complex shapes and reducing the overall carbon footprint. The successful fabrication of the thermoformed laminates helps increase the applications of renewable fibers for partially biobased composite materials in higher value applications.

### Methodology

### Sample Specification

Nonwoven sisal fiber mats were used as the fiber reinforcement to develop the thermoformable prepregs.

### Fiber Characterization

Digital light optical microscope-Keyence® VHX-7000 Series was used to determine the average length, cross-section and aspect ratios of the fibers in the preform. About 50 fiber specimens were sampled to characterize these physical aspects. Apart from determining the physical dimensions, it was also critical to understand the fiber cross-section. Knowing cell lumen structure will help to quantify the resin volume fraction. Scanning Electron Microscopy (SEM)-TESCAN VEGA3 was used to capture the micro images of the cross-sections of the fiber bundle and the individual fibers, and the average diameter of the lumen structure. Eventually, the strength and modulus of the individual fibers, under tensile load, were calculated based on the ASTM D3822 standard. It will help to validate the composite rule of mixture theory for the final composite properties. Finally, thermal degradation and crystallinity studies were also conducted on the individual fibers using thermogravimetric analysis (TGA). The fibers were grounded in a Wiley Mill using 60 mesh screen before performing the TGA studies.

### Fiber Mat and Prepreg

The understanding of the material properties of the individual fibers will be followed by the understanding of the processing parameters and the final product properties. The VARTM process is carried out under a vacuum and thus imparts the atmospheric pressure of 1 bar when the vacuum is completely pulled. The non-woven binder-free fiber mat is compacted under pressure imparted by the vacuuming process. Therefore, it is important to understand the compaction ratio of the fiber mats before and after the vacuum is pulled to develop a relationship between the initial and final product thickness. VARTM, as mentioned earlier, will be used to produce prepregs from the non-woven sisal fiber mats of the desired thickness. The amount of resin impregnated in the prepregs can also be varied by changing the location of the outlet, an aspect which is also studied to understand the increase in resin content and time required for complete impregnation. A relationship will be further established to highlight the infusion time of the resin per inch of the preform when the resin flow front is constant across the width. Eventually, the weight, prepreg density and fiber volume fraction were calculated and compared between the two processing techniques to establish the hypothesis of increased resin impregnation.

SEM was used to examine resin encapsulation of fibers and lumen penetration, if any. TGA and differential thermogravimetric (DTG) analyses were carried out to understand the thermal degradation and mass loss. Dynamic Mechanical Analyzer (DMA) was implied to estimate the glass transition temperature, storage modulus, temperature for beta (β) transition and the range in which the composite becomes rubbery. DMA was also utilized to calculate the flexural properties of the prepregs. Finally, tensile properties, water absorption and thickness swelling behavior were analyzed based on ASTM D1037-13, and the values will be compared with established strand-based and synthetic fiber prepregs. The rule of mixture was applied and compared to the experimental results to examine the applicability of these simplified micromechanic models to predict the properties of natural fiber-based composites.

### Composite Laminates

A detailed understanding of the final VARTM product will further help establish the ideal thermoforming temperature and target properties for making the composite laminates. The thermoforming process will be followed based on the same method established in Example 1. The thermoformed flat laminates will be further used to calculate the thickness, density, weight and fiber volume fraction. A density profiler will demonstrate the uniformity in the horizontal density profile. The surface roughness of the laminates was calculated and compared to that of the prepregs using the 3D profiling capabilities of the digital light optical microscope-Keyence VHX-7000 Series available at CMEC, WSU. Tensile tests will again be carried out based on ASTM D1037-12 and the flexural tests will be carried out based on the ASTM D790 standard. Since sisal fiber is known to have good impact strengths, the pendulum impact tester was also used to calculate the impact strength based on the ASTM D256-10 standard. Finally, water absorption and thickness swelling was carried out to illustrate the excellent water-repelling properties of the laminates. The results were compared to laminates developed from wood-based prepregs and those from established synthetic fibers based on the literature.

### Results and Discussion

### Fiber Properties and Characterization

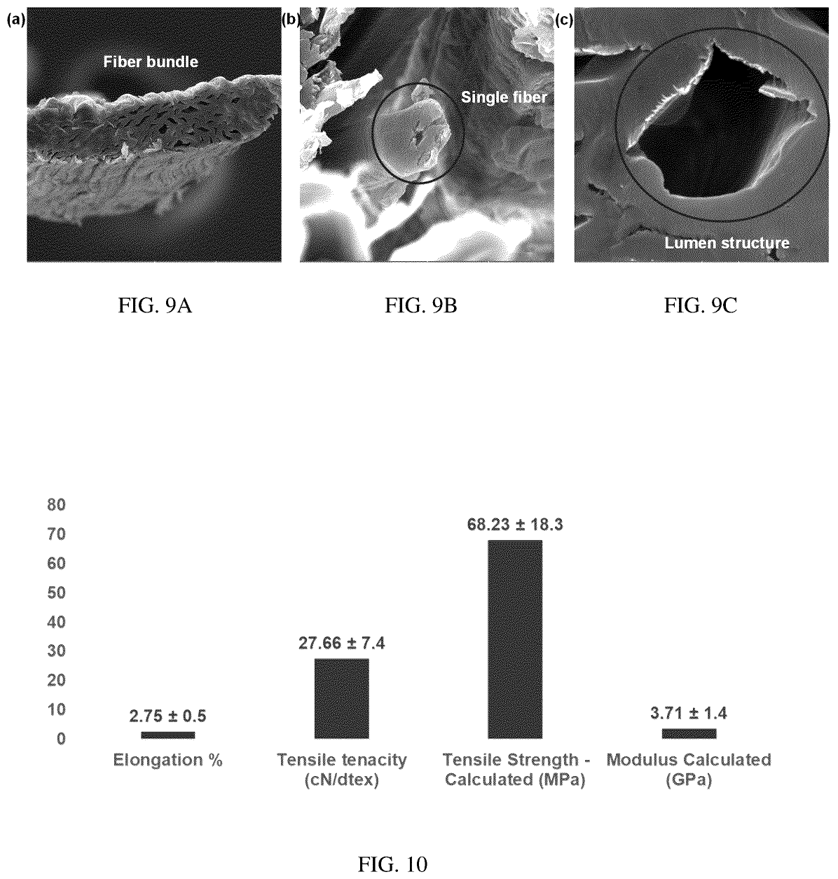

The digital light optical microscope was used to measure the dimensions of the fibers to understand the distribution and the aspect ratios, Table 4. The fibers used to build the non-woven mats can be classified as a type of long fiber. The dimensional analysis also helped calculate the fibers' cross-sectional area, which will be utilized to achieve the tensile modulus and strength. Sisal, a natural fiber, has significant variations in strength and structure. Therefore, it is important to illustrate the lumen structures, FIG. 9 and the strength of the individual fibers, FIG. 10.

TABLE 4
Dimensional properties of the sisal fibers.

| | | | Cross-sectional |
|---|---|---|---|
| Length (mm) | Width (mm) | Aspect Ratio | Area (mm²) |
| 33.7 ± 4.5 | 0.19 ± 0.06 | 252.2 ± 79.5 | 0.07 ± 0.03 |

Scanning Electron Microscope was utilized to observe the lumen structures, as can be seen in the illustrations in FIG. 9. The lumen structures can be classified as partially circular and partially octagonal, which can be attributed to the cutting pressure resulting in slight deformations. The micrographs proved that the diameter of the lumen structures is roughly in the range of 8 μm and 12 μm. Therefore, these lumen structures may not always be 100% saturated with resin after infusion, even though partial saturations will also help in the strength of the composites.

The tensile strength of the individual fibers was also calculated through single-fiber testing according to ASTM D3822/D3822M-14. It should be noted that the sisal fibers were observed to be pretty uniform in cross-section throughout the length under LOM, and therefore, for case of calculation, the cross-sectional area was assumed to be consistent along the length. The tenacity of the fibers was calculated to be 27.66 N/tex, with about 2.75% of elongation, 68.23 MPa of tensile strength and 3.71 GPa of tensile modulus. These values represent the quality and dimensions of the sisal fibers used. Changes in these dimensions and quality often result in a change in the tensile properties, where studies have shown moduli to be as high as 7 GPa and tenacities to be as high as 50 N/tex.

### Resin Impregnation and Other Process Properties During VARTM

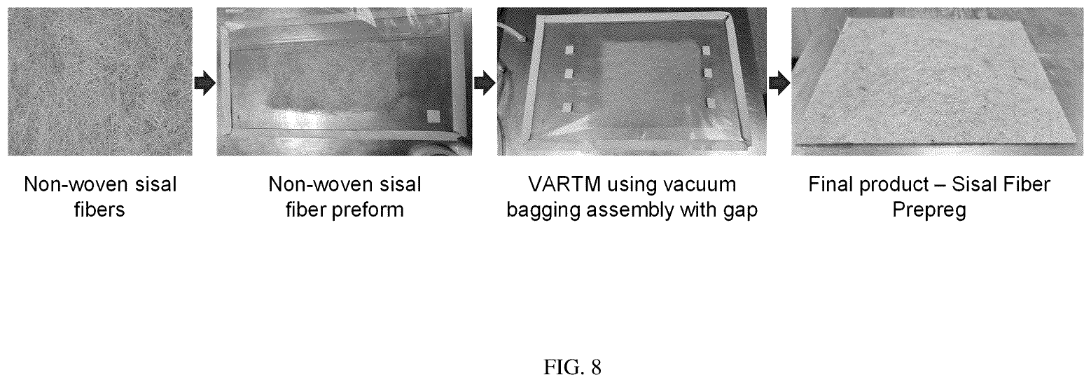

With the details of the individual fibers established, it is critical to understand the various aspects influencing the experimental process used, vacuum assisted resin transfer molding. The process involves pulling a vacuum on the preform, FIG. 8, with the aid of which the resin is pulled from the inlet towards the outlet, where the vacuum pump is connected. This vacuum imparts 1 bar of atmospheric pressure on the preform once the vacuum is completely pulled. This pressure results in modifying the final preform height, an aspect known as the compaction ratio. It is important to understand the compaction ratio of the preforms for a particular bulk density to achieve the ideal height of the individual prepregs, Table 5. The final thickness of the cured layer completely depends on the compaction ratio and the preform thickness achieved after the vacuum has been pulled. Again, this compaction ratio will change if the bulk density of the fibers used changes.

The bulk density of the acquired fiber mats was calculated to be 24.9±0.2 kg/m³ for which the compaction ratio was observed to be about 2.44±0.18, with a compaction percentage of about 244%. The bulk density was calculated using the established formula of D=M/V, where D is the bulk density to be calculated, M is the weight of the container being used when filled with the fibers, and V is the known volume of the container. Therefore, with the calculated compaction ratio, the final thickness of the prepregs was about 2 mm, while the initial thickness was about 4.83 mm. Higher initial thicknesses will result in thicker prepregs and vice-versa. The increase in bulk density will directly result in decreased compaction ratio and vice-versa.

TABLE 5
Compaction ratio of the used fiber mats due to vacuum pressure.

| | Final | | Compaction |
|---|---|---|---|
| Packed Preform | Prepreg | Compaction | Percentage |
| Thickness (mm) | Thickness (mm) | Ratio | (%) |
| 4.83 ± 0.25 | 2.03 ± 0.25 | 2.44 ± 0.18 | 244 ± 18.5 |

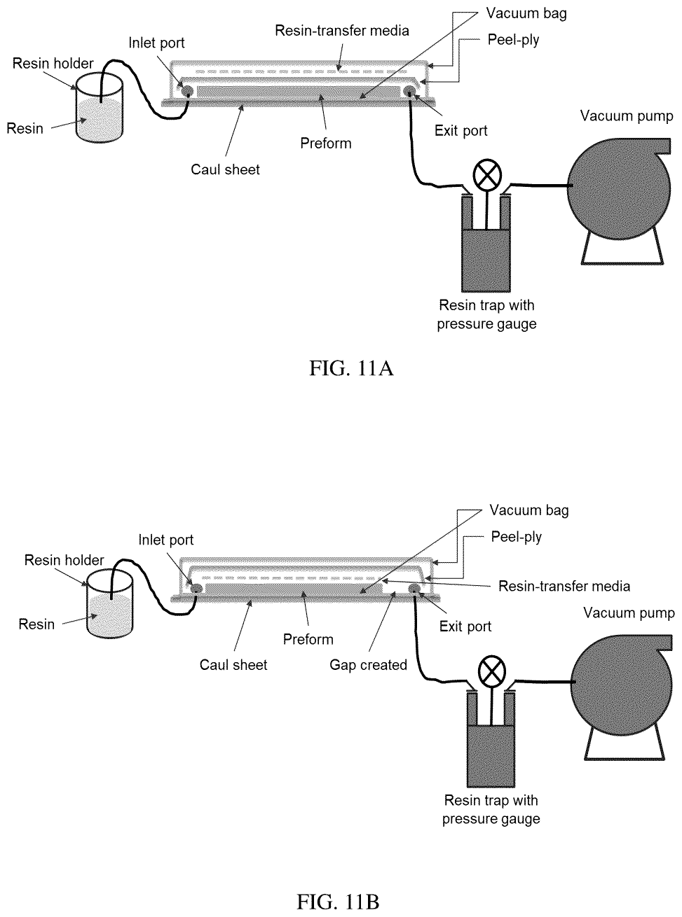

The amount of resin infused inside the preform during VARTM has generally been processed and material dependent. However, the studies carried out by the authors prove that the resin content can be varied to some extent, which is directly related to the location of the outlet port. Increasing the gap between the preform boundary and the outlet port by 101.6 mm, which is generally done to improve the thickness penetration of the resin in thicker preforms, helps in increasing the amount of resin content in the prepregs by about 44%, while the time to complete the infusion process also increases by 140%, Table 6 and FIG. 11A-B. The average infusion time per inch can be calculated as about 4 sec/in for general assemblies with both inlet and outlet at the preform boundary, Table 6. This average time increases to about 9 in/min as the gap between the preform boundary and outlet increases by 4 inches. Therefore, the results can be extrapolated to find a relation between the resin flow time per inch and the distance between the preform boundary and outlet port. This relation can be concluded to be directly proportional to the gap, with an increase in time of about 31.25% when the gap increases by 25.4 mm (1 inch). This relation is important while processing the prepregs to estimate the time required based on the desired gap between the preform boundary and the outlet.

TABLE 6
Relationship between resin flow and time for specific
VARTM assemblies

| | | Average time per inch | |
|---|---|---|---|
| | Average time | (sec/in) | |
| Average time | with ~101.6 mm | Without | |
| without gap (sec) | gap (sec) | gap | With gap |
| 41 ± 1.4 | 98.5 ± 9.2 | 0.15 ± 0.02 | 0.35 ± 0.03 |

### Analytical and Mechanical Properties of Prepreg

The details of the individual fiber dimensions, structure and strengths will significantly influence understanding many aspects of the fiber mat used, the strength properties and the possible fiber matrix interaction through saturation of the fibers' lumen structures. The established relationship between the gap and resin flow time can be extended to that between the gap and the resin content in the cured prepregs. It will directly help in understanding the desired gap for optimal resin content, and the previously established relationship will help establish the average time required for the infusion process. The increase in resin content is again directly proportional to the increase in the gap, with a possible mathematical relationship of about a 9% increase in resin content with every 25.4 mm (1 inch) increase in the gap, Table 7. The increase in resin content also increased the weight of the cured prepregs and thus, resulting in increased density and reduced fiber volume fraction, Table 12. Therefore, it can be concluded that the increase in resin content will be accompanied by reduced fiber volume fraction, and thus, the strength will also be reduced. Since the assembly without gap results in higher fiber volume fractions, the remaining part of the study will be conducted on the prepregs fabricated using the traditional method with no gaps between the outer boundary of the preform and the outlet port. Thus, the prepregs used for performing the subsequent thermal analysis, dynamic mechanical analysis, tensile and bending tests, micro-graphical studies and eventual thermoforming have fiber volume fractions of 29.6±6.7 and densities of 816±68.9 kg/m³.

TABLE 7
Comparative illustration of the possible variation in resin content
and prepreg quality dependent on the outlet's positioning.

| Without gap | | | | With gap | | | |
|---|---|---|---|---|---|---|---|
| | | Fiber | | | | Fiber | |
| Thickness | Weight | volume | Density | Thickness | Weight | volume | Density |
| (mm) | (gm) | fraction | (kg/m³) | (mm) | (gm) | fraction | (kg/m³) |
| 1.96 ± | 77.9 ± | 29.6 ± | 816 ± | 2.06 ± | 102.6 ± | 16.6 ± | 940.3 ± |
| 0.25 | 12 | 6.7 | 68.9 | 0.25 | 12.7 | 2.2 | 70.5 |

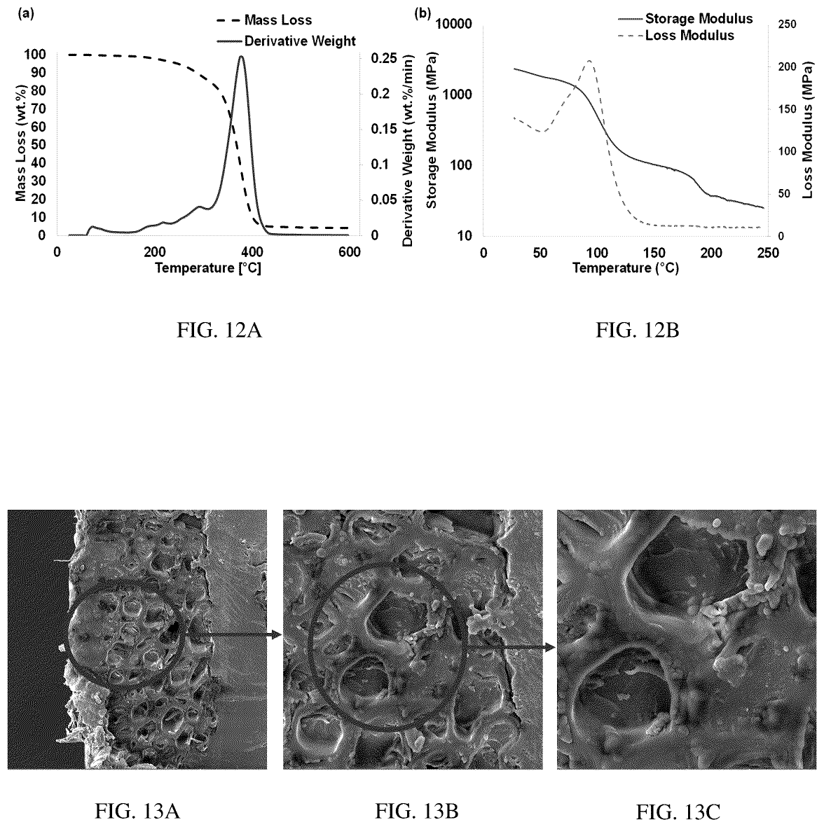

The density of the prepregs were also analyzed using a density profiler, which uses x-rays to calculate the density at each point of the surface exposed for 9 samples. The average density value from the profiler was 863.6±165, which only showed a 5% variation from the calculated values. Therefore, it can be established that the preforms had uniform density throughout the entire length of the samples. The thermogravimetric analysis showed that the composites experienced peak mass loss at about 380° C., and the residual mass was 4.7%, proving that the lignocellulosic fibers helped form some charred residue after pyrolysis, FIG. 12A. The pyrolysis range was also observed to lie between 235° C. and 433° C. When compared to pure Elium®, these results show that the peak mass loss shifts by 10° C. due to the inclusion of sisal fibers, and the pyrolysis range also changes with the same being in the range of 200° C. to 400° C. for Elium®. The mass loss also increases for the composite, with Elium® having 0% residue after 500° C. Therefore, the composite becomes thermally more stable due to the presence of the sisal fibers.

The primary goal of developing the prepregs is to eventually thermoform them into laminates. Therefore, it is critical to observe the ideal thermoforming temperature, which can be estimated through dynamic mechanical analysis (DMA), FIG. 12B. The analysis helped establish the ability to store energy to be about 2.3 GPa, with the glass transition temperature of the polymeric composite being about 96° C., Table 8. The composite was also observed to achieve ductility at ˜107° C., with it being in the rubbery form in the range of 125° C. to 185° C. It proves that to achieve good bonding between the prepregs during thermoforming, the temperature should be between 125° C. and 185° C. Previous studies on Elium® composites also demonstrated that higher thermoforming temperatures in the rubbery range resulted in composites with greater shear strengths [2]. Therefore, the previously established temperature of 180° C. seems ideal according to DMA analysis because 185° C. might result in the phase change, and discoloration and degradation of the resin might initiate, which is common at 200° C. and higher. The TGA results in further support the same, as the pyrolysis for neat Elium® starts at 200° C., proving the temperature of 180° C. to be safe without any possible degradation.

TABLE 8
Results obtained from the DMA analysis of the prepregs.

| | Glass Transition | β transition- | Temperature range at |
|---|---|---|---|
| Storage | Temperature | Composite | which the composite |
| Modulus | (T_{g}) | achieves | becomes |
| (MPa) | (° C.) | ductility (° C.) | rubbery (° C.) |
| 2343.64 ± 30 | 95.9 ± 7.4 | ~107 ± 2.5 | ~125-185 |

One of the most important aspects of any natural or synthetic fiber-reinforced composite fabrication technique is the extent of fiber saturation experienced. Previous micrographs have proven that the sisal fibers consist of circular lumens, which are very small and have the possibility of partial resin impregnation. The hypothesis has been proved correct in FIG. 13A-C where excellent penetration in the lumen structures can be observed. Detailed SEM analysis demonstrated that most lumens resulted in resin penetration and encapsulation, resulting in an efficient composite. The results also prove that the rule of mixture, generally used for synthetic composites, can be applied in the current natural fiber composite prepregs and even laminates. The fiber matrix interaction also enhances due to the resin penetration resulting in the ideal behavior of the composite.

With the majority of the analytical aspects established, and the good fiber-matrix interaction proven, the mechanical properties of the prepregs were calculated based on ASTM D1037-13. The achieved results are illustrated in Table 9. Five samples for each test type were used to achieve the results. ASTM D1037-13 was used to compare the results between known wood-based products that might have similar end usage. The tensile strength of the prepreg was calculated to be about 19 MPa, which is relatively low compared to that of the individual fibers and that of the Elium®, which is about 76 MPa. The rule of mixture was also used to calculate the expected strength and modulus of the composites using the following equations:

$${TS}_{P} = {v}_{F} {TS}_{F} + {v}_{R} {TS}_{R} \& {E}_{P} = {v}_{F} {E}_{F} + {v}_{R} {E}_{R} \qquad ( 1 )$$

where TS is the tensile strength, v is the volume fraction, and E represents Young's modulus, while the suffixes P stand for prepreg, F stand for fiber, and R stand for resin.

When calculated using Eq. (1), the tensile strength was 73.67±0.5 MPa, which is about 74% higher than the actual value. This variation can be easily justified due to the orientation of the fibers. The non-woven fiber mat fabricating the prepregs had random fiber orientations, FIG. 8, resulting in reduced strength in one direction. However, the strength is similar in both directions of the prepregs, making it isotropic. The bending modulus was observed to be about 4.7 GPa, which on the other hand, was very similar to the predictive value of ˜3.4 GPa, achieved from Eq. (1), having a variation of only about 25%. It proves that the rule of mixture can provide a rough prediction of the properties, especially modulus and even strength, when all the fibers are oriented in the longitudinal direction. A comparison of the modulus with the wood-strand reinforced Elium® prepregs, oriented in the longitudinal direction, proves that the sisal prepregs had significant stiffness, only 40% less than that of the wood-strand-based prepregs.

TABLE 9
Mechanical properties of the prepregs.

| Tensile | Tensile | Flexural | Flexural | Water | |
|---|---|---|---|---|---|
| Strength | Modulus | Strength | Modulus | absorption | Thickness |
| (MPa) | (GPa) | (MPa) | (GPa) | (%) | swell (%) |
| 18.7 ± 2.3 | 4.77 ± 0.5 | 22.86 ± 2.1 | 5.1 ± 0.3 | 9.5 ± 0.64 | 4.06 ± 0.14 |

The flexural strength of the prepregs was calculated to be about 23 MPa with a high modulus of 5.1 GPa. Again, the relatively low strength can be attributed to the fiber orientation, and thus the tabulated properties in Table 9 are valid for both longitudinal and transverse directions. The bending modulus was again relatively high and comparable to hot pressed (˜50%) and CRTM epoxy panels (˜60%). Water absorption and thickness swelling results showed excellent properties, with only ˜9.5% mass increase due to water absorption and ˜4.1% thickness increase due to swelling experienced from water absorption, Table 9. General wood-based hot-pressed structures show about 80% and 20% water absorption and thickness swelling, respectively, whereas epoxy-based compression resin transfer molded panels usually perform better with roughly 4% and 1.5% water absorption and thickness swelling, respectively. Prepregs can have small voids that might result in water penetration, which is expected to be drastically reduced when thermoformed into laminates.

### Thermoforming Parameters

The DMA analysis helps establish the glass transition temperature of the prepregs to be around 96° C. and the thermal degradation to start at 235° C. Moreover, the rubbery state of the prepregs were established to be 125° C. to 185° C. Generally cellulose starts to degrade at around 220° C. and sisal being a lignocellulosic fiber, this aspect is critical for considering thermoforming temperature. Therefore, a temperature above 180° C. is not suitable for thermoforming the sisal-reinforced Elium® prepregs. Furthermore, previous studies have also established that 180° C. forms the ideal forming temperature considering the behavior of Elium® above that temperature and decreased strength in the composites below 180° C. Therefore, the temperature of 180° C. has also been adopted in the current study. A similar demonstration of varying pressure has also been carried out in the literature, where 830 kPa was established to be the ideal pressure with the highest inter-laminar shear stresses. Thus, the pressure applied during thermoforming was also maintained at 830 kPa. Another critical aspect of the thermoforming process that has already been established is to hold the pressure under the desired temperature for 25 minutes (6 minutes for the temperature to reach the core) and 19 minutes to ensure ideal resin encapsulation and distribution. Additionally, it was also established by the group that cooling down the mold under pressure to less than 80° C. before taking the laminates out helps in consistent, flat samples with negligible warping and the highest interlaminar shear strength. All these aspects were also followed in the current study, with the thermoforming parameters detailed in Table 10.

TABLE 10
Thermoforming parameters used.

| No of | | Pressure | Temperature | |
|---|---|---|---|---|
| layers | Orientation | (psi) | (º F.) | Time (sec) |
| 5 | Unidirectional | 120 | 356 | 25 |

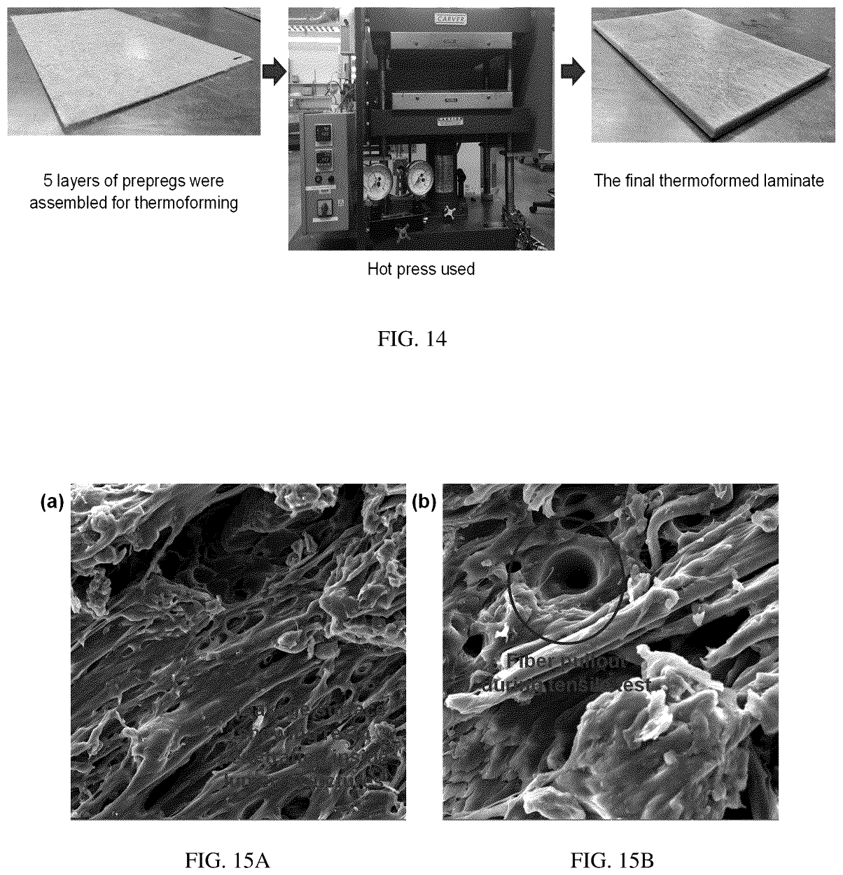

In order to make stable composite laminates, 5 prepregs were used to thermoform flat composite laminates. 3 such laminates were formed for testing. Since non-woven mats were used, the orientation of the sisal fibers was random, resulting in isotropic preforms and, eventually, isotropic laminates. All the prepregs were laid up in the same direction to observe the maximized mechanical properties. A hydraulic press was used to thermoform the laminates with the parameters and lay-up, as illustrated in Table 10. The graphical illustration of the thermoforming process and the final laminate achieved is shown in FIG. 14. The thermoformed laminate experienced a slight color change, possibly due to the thermoforming temperature being slightly higher than desirable for the compositions. However, apart from the moderate color change, all other aspects were as expected, with the final product being aesthetically more pleasing.

### Composite Laminate Analytical and Mechanical Properties

The laminates thermoformed from the prepregs showed excellent dimensional stability with excellent resin encapsulation on the outer surfaces. The total thickness of the laminates was around 8 mm, Table 11, where each prepreg was about 1.96 mm. It shows that the prepregs consolidate and shrink by about 18% (1.8 mm) under pressure and temperature to form the final composite panel. The density of the final laminates was manually calculated to be around 1150 kg/m³. A density profiler was used to calculate the density. It also helped establish uniformity in density through the thickness of the laminate all along the span. The results were impressive with the average density estimated at 1130 kg/m³, with only a 1.8% variation from the manually calculated one. The lower standard deviation proved that the value was extremely consistent throughout the panel. Finally, the fiber volume fraction of the panels was calculated to be around 31%, whereas those of the prepregs were around 29%, resulting in a ˜2% increase in fiber volume fraction.

TABLE 11
Dimensional properties of the thermoformed laminates.

| Thickness | Weight | Volume | Fiber Volume | Calculated | Density Profiler |
|---|---|---|---|---|---|
| (mm) | (gm) | (mm³) | Fraction | Density (kg/m³) | (kg/m³) |
| 8 ± 1.2 | 325.2 ± 2.6 | 2.91E5 ± 0.6 | 31.2 ± 4.3 | 1153.3 ± 65.7 | 1128 ± 72.1 |

The individual weight of the laminates was about 325 gm, with the prepregs weighing about 78 gm only. Thus, about 16% of weight loss is experienced from the prepregs to that of the final panel, which can be attributed to higher pressure and consolidation that can help with increased resin penetration and encapsulation, decreased void content and greater fiber-matrix interaction. The variation in heights, usually seen in the prepregs, will also be minimized to achieve a more consistent and denser product. The increase in density by about 24% proved that the final laminate is more condensed, which justifies the loss in mass. The surface roughness was also measured for the prepregs and the laminates using the 3-dimensional profiling capabilities in the Keyence LOM, available at CMEC, WSU. The laminates showed extremely smooth surfaces with almost 99%, 63.4% and 93.2% increases in arithmetic mean height (Sa), root mean square height (S_{q}) and maximum height (S_{z}), respectively, when measured on both the top and bottom surfaces of the samples. It further establishes that the extremely flat laminates were achieved with negligible undulation.

The mechanical properties of the laminates are reported in Table 12. The tensile strength was about 33 MPa, which is more than the previously studied wood-strand-based prepregs. The strength is also comparable to hot-pressed panels, although the thermoformed laminated from wood-strand-based prepregs showed more than twice the strength. There are two definite reasons behind the variation. One is the presence of wood, one of the most potent natural products. The second was that the prepregs were made with strands oriented in a particular direction, and the laminates were made from unidirectional prepregs, giving excellent strength to the laminates in the longitudinal direction but lower stability in the transverse direction. Interestingly, the current sisal-based laminates being isotropic, the strength will be similar in both directions, making the panels ideal for interior decorative panels, automobile and aerospace parts and other similar non-structural applications. The tensile modulus was established to be ˜5.5 GPa, again lower than the comparative parts but significantly higher than thermoplastic polymers, including polypropylene (˜1.9 GPa), nylon 6 (˜1.8 GPa), polycarbonate (˜2.6 GPa) and other similar polymeric materials and fiber reinforced thermoplastic polymer composites.

TABLE 12
Mechanical properties of the thermoformed laminates.

| Tensile | Tensile | Flexural | Flexural | Impact | Water | |
|---|---|---|---|---|---|---|
| Strength | Modulus | Strength | Modulus | Resistance | absorption | Thickness |
| (MPa) | (GPa) | (MPa) | (GPa) | (kJ/m²) | (%) | swell (%) |
| 32.8 ± 5.6 | 5.5 ± 0.27 | 20.8 ± 1.8 | 3 ± 0.2 | 17.4 ± 1.7 | 3 ± 0.24 | 1.17 ± 0.39 |

Analytical verification of the properties using the rule of mixture, Eq. (1), showed similar variations when compared to those of the prepreg, ˜50% for strength and ˜36% for modulus, which can again be attributed to the random fiber orientation of the non-woven sisal fiber mats. The micrographs on the tensile coupons at the breakage surface, FIG. 15A-B, prove that some fibers experienced pullout, whereas others experienced breakage. This might also result in reduced strength when compared to the predicted ones as the adhesion between fiber and matrix might not be sufficient and the same throughout the thickness of the laminates. The flexural studies showed similar strength values compared to prepregs, whereas the modulus decreased by about 40%. This is majorly due to the thermoforming process, where studies have shown that flexural properties, especially modulus, reduce after thermoforming, especially for thicker materials (>1 mm). The influence of the thermoforming results in decreased thickness which can also result in reduced flexural properties. The impact resistance of the laminates was also calculated to be about 17 KJ/m², Table 12. General natural fiber reinforced polymer composites, without fillers, show impact resistance of about 2 KJ/m². Studies have shown that including poly(ethylene terephthalate) fibers as fillers to wood, jute and palm fibers helps increase their impact resistance to about 15 KJ/m². On the contrary, the developed sisal fiber reinforced polymer laminates themselves have about 88% higher resistance compared to neat natural fiber composites and ˜12% higher strengths when compared to the specially treated ones.

The dimensional stability, water absorption and thickness swelling, of the laminates were exceptional and again contradictory to general natural fiber composites, where dimensional stability is always an issue. The results illustrated in Table 12 proved that the water absorption and thickness swell are ˜68% and 71% lower than the sisal-prepregs, ˜25% and ˜41% lower than wood-strand laminates, ˜40% and ˜41.5% lower than epoxy infused natural fiber panels, and ˜95% and ˜94% lower than hot pressed wood-based panels. Therefore, it can be concluded that fabricated laminates are one of the most dimensionally stable natural fiber-reinforced polymer composites.

### Conclusion

A natural fiber-reinforced thermoplastic prepreg has been developed, which can substitute commonly used synthetic fiber prepregs. These prepregs can be used for manufacturing molded parts for various applications, including architectural, decorative, aerospace and automotive industries. Non-woven sisal fiber mats were used to develop the natural fiber-based prepregs using a vitrimer polymer and vacuum assisted resin transfer molding technique. The low viscosity of the resin used enabled penetration of the resin inside the lumen structures, an aspect typically not seen with traditional thermoplastic resins. These helped in fabricating high-performance prepregs with low void contents. The various material characteristics outlined, the process parameters established and the product properties tested helped develop a detailed material-process-product relationship for non-woven sisal fiber mats when used with a thermoplastic resin during vacuum assisted resin transfer molding. The previously established thermoforming parameters were used to achieve the final laminates that had good mechanical properties in tensile, flexural and impact resistance and exceptional dimensional stability with negligible water absorption.

### Example 3

### Materials and Methods

Low quality spruce pine fire lumbers were acquired from IDAHO Forest Group. The lumbers were cut into ˜5″ of length and soaked till fiber saturation point was reached. Disc strander was used to achieve the final strands with aspect ratio (L/t) of ˜250. The strands were laid up and then stitched. After stitching, the preforms were dried in the oven till moisture content was less than 1%. The same VARTM technique for resin impregnation as set forth in Example 1 was performed. Elium® grade 150 resin was used having a viscosity of 100 cps.

### Results

### Analytical and Mechanical Studies

The resin infusion process helped increase the density of the strands by ˜50%. SEM analysis proved that the empty pores were majorly filled with resin, proving excellent resin penetration. The resin infused strand experienced ˜71% and ˜52% decrease in water absorption and thickness swell, respectively, proving better dimensional stability.

Thermogravimetry analysis proved that although the infusion process results in higher mass loss by ˜76%, the reference temperature remains the same (˜330° C.) and the pyrolysis range shifts from 228° C.-395° C. to 234° C.-438° C., increasing the thermal stability.

The tensile tests further proved that the resin infusion process made the strands stronger with ˜33% increase in strength, while having similar modulus values.

Dynamic Mechanical Analysis was also carried out to primarily observe the storage modulus of ˜2.34 GPa and the thermoforming (rubbery state) temperature range of 125° C. and 185° C.

### Establishing Thermoforming Process Parameters

Shear testing according to ASTM D1037 of the laminates was carried out to observe the ideal thermoforming parameters that give the best strength. The variables include: ideal time to release pressure, ideal forming temperature, and ideal forming pressure. The first variable was ideal when the pressure is released after cooling down to a level where the polymer is solid (<80° C.). The ideal forming temperature based on DMA analysis of Elium® composites was 180° C. The ideal forming pressure was 120 psi.

### Laminate Orientation

The strand orientation is important while forming large curvature structures from the prepregs. Single axis forming is achievable with unidirectional prepregs. During bi-axial and multi-axial forming, it is important to have a balanced strength in both longitudinal and transverse directions of the laminates. FIG. 16A-E shown the different orientations tested for the 5 prepreg layers within the laminate. Based on the orientation of the prepregs within the laminates, a tensile strength between 25 and 80 MPa and a tensile modulus between 2.5 and 10.5 GPa in the strong axis direction can be achieved; whereas, bending strength between 84 MPa and 140 MPa and bending modulus between 5 and 12 GPa about the strong axis can be achieved. These laminates also exhibit very low water absorption (less than 4%) and thickness swell (less than 1.5%) when soaked in water for 24 hours.

### Forming Parameters

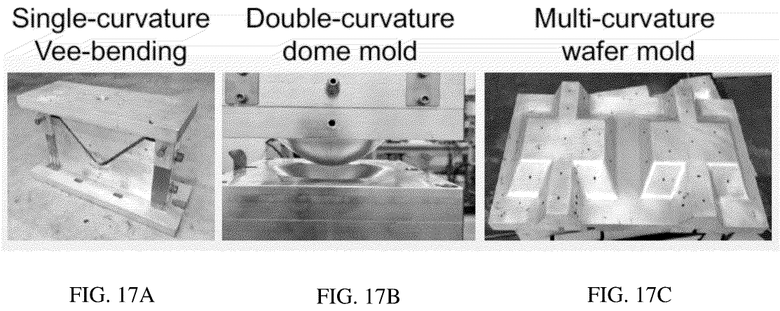

As shown in FIG. 17A-C, three types of forming were tested: single-axis forming (vec-bending), bi-axial forming (dome forming), and multi-axial forming (3D wafer mold).

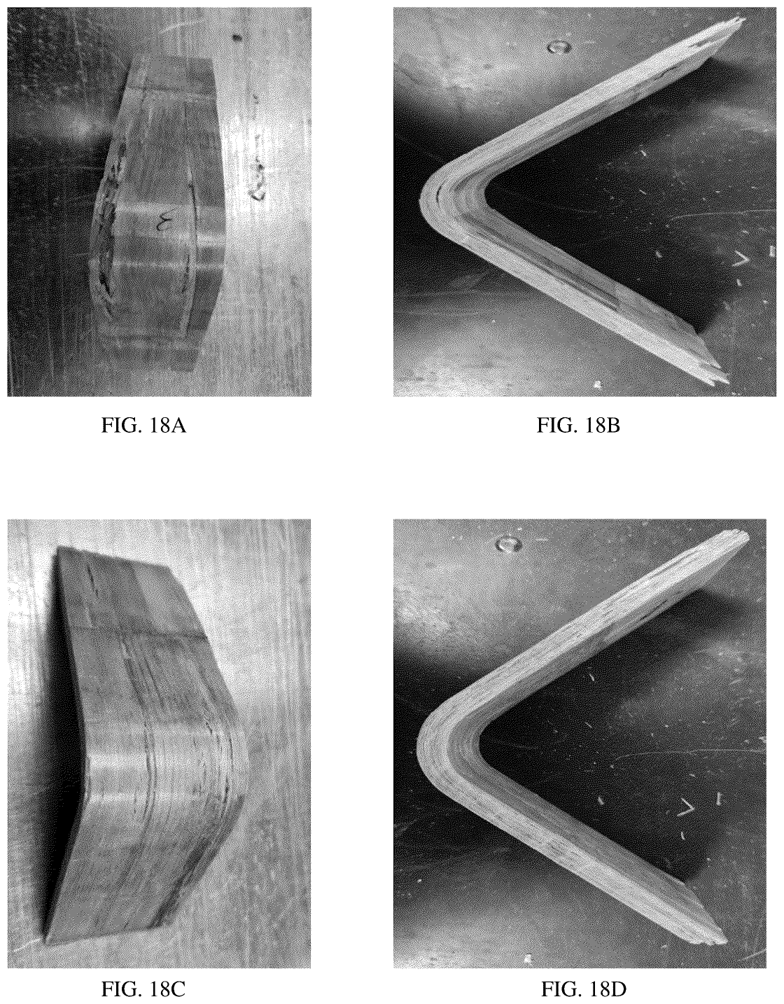

For vee-bending, the forming ratio was used similar to that established in sheet metal forming studies: 2≤r/t≤3, where r is the radius of forming and t is the thickness of the laminate formed. The forming radius for the study was 1″, and the forming ratio of 3 was established to work for single axis forming, with 12 prepregs, each being about 0.028″ thick. The forming rate of 0.5 in/min resulted in acceptable samples with minimal defects and excellent lamination between the prepregs (FIG. 18C-D). The forming rate of 1 in/min resulted in defects (FIG. 18A-B). A thickness reduction of about 40% was calculated due to the pressure, consistent with thermoforming flat laminates.

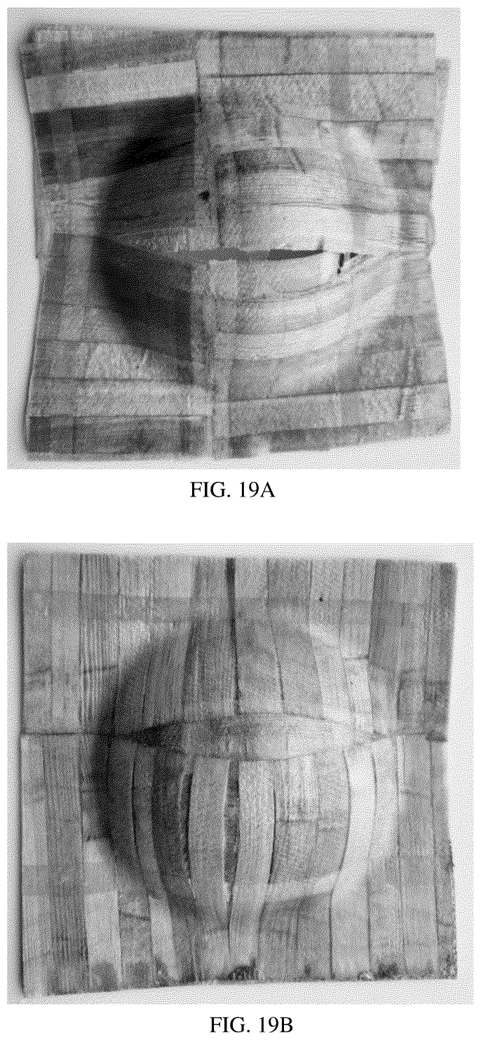

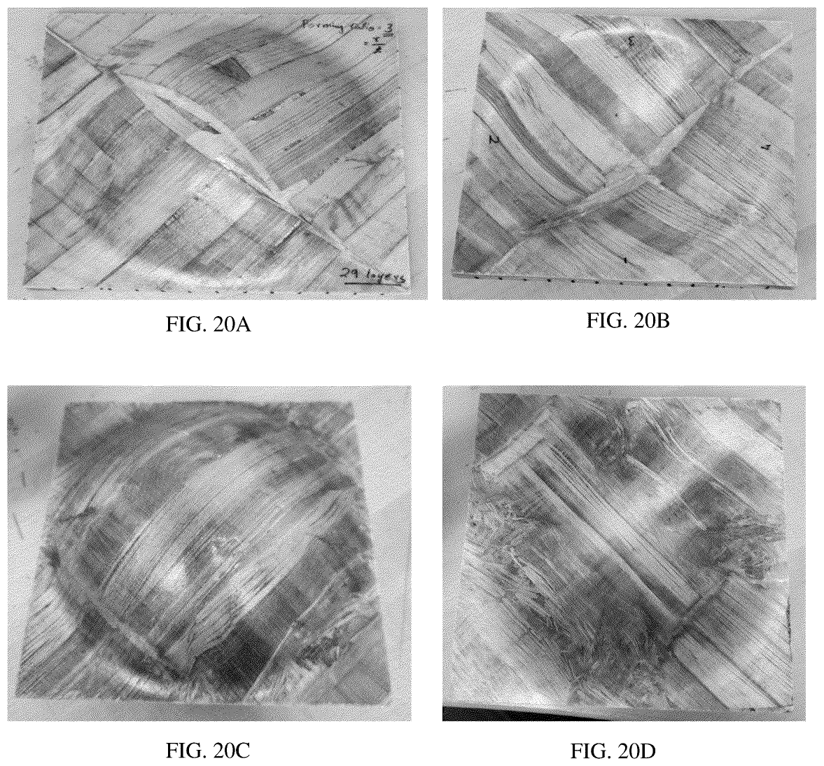

For dome-forming, the ideal layup was established from the orientation study to be (+45°/−45°) n/0°/(+45°/−45°)n. A forming rate of 0.1 in/min was ideal whereas a forming rate of 0.5 in/min produced defects (FIG. 19A-B). The laminate size to forming span ratio was established to be 1.07. The forming ratio of 2 was proven to work in successfully achieving the desired shape while a forming ratio of 3 produced defects (FIG. 20A-D). The thickness reduction due to pressure from estimated to calculated was ˜38%.

For multi-axial forming, 9 prepregs, in) (0°/90°)4/0°/(90°/0°)4 orientation was used to form the 0.25″ 3-D panel, as each prepreg was about 0.028″ thick.

### Recyclability

The tested strands and laminates were knife milled into smaller particles. The milled particles were mixed with polypropylene (PP). The mixture was extruded using a twin-screw extruder. The filaments were palletized and then injection molded. The recycled materials were found to have excellent mechanical properties.

### Conclusion

High quality prepregs with excellent mechanical properties can be achieved from strands processed from small diameter timber (SDT) feedstocks. The prepregs can be used to thermoform high quality flat laminates that are dimensionally stable and extremely light-weight, providing a minimum of 50% weight savings from common alternatives. The ideal thermoforming parameters were established to be 180° C., 120 MPa, 19 minutes of consolidation, and cooling down to <80° C. before releasing the pressure. The +45°/−45/0°/+45°/−45° orientation was established to be ideal for bi-axial forming of the laminates. Uni-directional laminates were able to produce single-axis forming with a forming ratio of 3 and forming rate of 0.5 in/min. Bi-axial forming was successfully carried out with laminates having the orientation of (+45°/−45°)n/0°/(+45°/−45°)n, with forming ratio of 2. Recyclability of these materials is possible and proven, resulting in carbon sequestration. This can be further extended into many internal automobile applications including but not limited to seats, dash boards, glove boxes and other interior panels.

It should be emphasized that the above-described embodiments and specific examples of the present invention, particularly, any “preferred” embodiments, are merely possible examples of implementations, merely set forth for a clear understanding of the principles of the invention. Many variations and modifications may be made to the above-described embodiment(s) of the invention without departing substantially from the spirit and principles of the invention. All such modifications and variations are intended to be included herein within the scope of this disclosure and the present invention and protected by the following claims

1. A method of preparing a plant-based prepreg, comprising:
adhering a plurality of plant fibers or strands to form a preform;
enclosing the preform within a vacuum bag having an inlet and outlet;
applying a vacuum pressure to the vacuum bag;
passing a resin through the inlet to infuse the resin into the preform; and
removing the vacuum bag to provide the plant-based prepreg.

2. The method of claim 1, wherein the resin is a liquid thermoplastic resin.

3. The method of claim 1, wherein the resin has a viscosity of 50-150 cps at 25° C.

4. The method of claim 1, wherein the plant fibers or strands are obtained from wood, sisal, hemp, or jute.

5. The method of claim 1, wherein the plant strands have an average thickness of 0.2 to 0.7 mm.

6. The method of claim 1, wherein the plant-based prepreg has an average thickness of 1-12 mm.

7. The method of claim 1, further comprising placing a resin flow media layer on an upper surface of the preform before the enclosing step and removing the resin flow media layer after removing the vacuum bag.

8. The method of claim 1, wherein the plurality of plant fibers are adhered and compressed to form the preform.

9. A plant-based prepreg prepared by the method according to claim 1.

10. A method of preparing a laminated composite material, comprising:
layering a plurality of plant-based prepregs prepared by the method according to claim 1; and
applying heat and compression to the layered plant-based prepregs to provide a laminated composite material.

11. The method of claim 10, wherein the applying step is performed by heating the layered plant-based prepregs to a temperature of 170-190° C. at a pressure of 810-850 kPa.

12. The method of claim 10, wherein the applying step is performed for 1-30 minutes.

13. The method of claim 10, further comprising cooling the laminated composite material to a temperature below 80° C. before removing the compression.

14. The method of claim 10, further comprising shaping the laminated composite material into a three dimensional configuration.

15. The method of claim 14, wherein the three dimensional configuration comprises a dome shape.

16. The method of claim 15, wherein the dome shape has a forming ratio of 2 or less.

17. A laminated composite material prepared by the method according to claim 10.

18. The laminated composite material of claim 17, wherein the laminated composite material is shaped into a three dimensional configuration.
